(19) United States
(12) Patent Application Publication
(10) Pub. No.: US 2024/0421944 A1
(43) Pub. Date: Dec. 19, 2024

(54) HARQ FEEDBACK METHOD AND APPARATUS, AND DEVICE AND STORAGE MEDIUM

(71) Applicant: Beijing Xiaomi Mobile Software Co., Ltd., Beijing (CN)

(72) Inventor: Xingyi LUO, Beijing (CN)

(73) Assignee: Beijing Xiaomi Mobile Software Co., Ltd., Beijing (CN)

(21) Appl. No.: 18/722,228

(22) PCT Filed: Dec. 21, 2021
(86) PCT No.: PCT/CN2021/140232

§ 371 Date: Jun. 20, 2024

(51) Int. Cl. H04L 1/1867; H04L 5/00

(52) U.S. Cl. CPC H04L 1/1896; H04L 5/0055

(57) ABSTRACT

An HARQ feedback method, a device and a storage medium are provided. The method includes: receiving, by a terminal, a beam indication signaling sent by a first access network device, wherein the beam indication signaling indicates a target beam to be used by the terminal; and in response to an access network device to which the target beam belongs being a second access network device, performing, by the terminal, HARQ feedback for downlink data through the target beam together with the second access network device.

### CROSS-REFERENCE TO RELATED APPLICATIONS

The present disclosure is the U.S. national phase application of International Application No. PCT/CN2021/140232 filed on Dec. 21, 2021, the content of which is incorporated herein by reference in its entirety for all purposes.

### TECHNICAL FIELD

The present disclosure relates to the field of mobile communication technology, in particular to an HARQ (Hybrid Automatic Repeat Request) feedback method and apparatus, a device, and a storage medium.

### BACKGROUND

In the mobile communication technology, a terminal and an access network device communicate with each other through beams, and the access network device can also configure beams used for a neighboring cell for the terminal, allowing the terminal to communicate with the access network device through beams used for the neighboring cell.

### SUMMARY

According to one aspect of the present disclosure, an HARQ feedback method is provided, the method is performed by a terminal and includes: receiving a beam indication signaling sent by a first access network device, wherein the beam indication signaling is configured to indicate a target beam to be used by the terminal; and in response to an access network device to which the target beam belongs being a second access network device, performing HARQ (Hybrid Automatic Repeat Request) feedback for downlink data through the target beam together with the second access network device.

According to one aspect of the present disclosure, an HARQ feedback method is provided, the method is performed by a first access network device, and includes: sending a beam indication signaling to a terminal, wherein the beam indication signaling is configured to indicate a target beam to be used by the terminal; and in response to an access network device to which the target beam belongs being a second access network device, indicating to the second access network device to enable the second access network device to perform HARQ (Hybrid Automatic Repeat Request) feedback for downlink data through the target beam together with the terminal.

According to one aspect of the present disclosure, an HARQ feedback method is provided, the method is performed by a second access network device, and includes: in response to an access network device to which a target beam belongs being the second access network device, receiving, through the target beam, HARQ feedback for downlink data sent by a terminal; wherein the target beam is indicated to the terminal by a first access network device through a beam indication signaling.

According to one aspect of the present disclosure, an HARQ feedback apparatus is provided, which includes: a receiving module configured to receive a beam indication signaling sent by a first access network device, wherein the beam indication signaling is configured to indicate a target beam to be used by the terminal; and a processing module configured to in response to an access network device to which the target beam belongs being a second access network device, perform HARQ (Hybrid Automatic Repeat Request) feedback for downlink data through the target beam together with the second access network device.

According to one aspect of the present disclosure, an HARQ feedback apparatus is provided, which includes: a sending module configured to send a beam indication signaling to a terminal, wherein the beam indication signaling is configured to indicate a target beam to be used by the terminal; and a processing module configured to in response to an access network device to which the target beam belongs being a second access network device, indicate to the second access network device to enable the second access network device to perform HARQ (Hybrid Automatic Repeat Request) feedback for downlink data through the target beam together with the terminal.

According to one aspect of the present disclosure, an HARQ feedback apparatus is provided, which includes: a processing module configured to in response to an access network device to which a target beam belongs being the second access network device, receive, through the target beam, HARQ feedback for downlink data sent by a terminal; wherein the target beam is indicated to the terminal by a first access network device through a beam indication signaling.

According to one aspect of the present disclosure, a terminal is provided, which includes: a processor; a transceiver connected to the processor; a memory for storing instructions executable by the processor; wherein the processor is configured to load and execute the executable instructions to implement the HARQ feedback method as described above.

According to one aspect of the present disclosure, an access network device is provided, which includes: a processor; a transceiver connected to the processor; a memory for storing instructions executable by the processor; wherein the processor is configured to load and execute the executable instructions to implement the HARQ feedback method as described above.

According to one aspect of the present disclosure, a computer-readable storage medium is provided, wherein executable program codes are stored, and the executable program codes are loaded and executed by a processor to implement the HARQ feedback method as described above.

According to one aspect of the present disclosure, a chip is provided, which includes programmable logic circuits and/or program instructions for implementing the HARQ feedback method as described above when the chip is running on a terminal or an access network device.

According to one aspect of the present disclosure, a computer program product is provided, which implements the HARQ feedback method when the computer program product is executed by a processor of a terminal or an access network device.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is a block diagram of a communication system according to embodiments of the present disclosure;

FIG. 2 is a block diagram of a communication system according to embodiments of the present disclosure;

FIG. 3 is a flowchart of an HARQ feedback method according to embodiments of the present disclosure;

FIG. 4 is a schematic diagram of HARQ feedback according to embodiments of the present disclosure;

FIG. 5 is a flowchart of an HARQ feedback method according to embodiments of the present disclosure;

FIG. 6 is a flowchart of an HARQ feedback method according to embodiments of the present disclosure;

FIG. 7 is a flowchart of an HARQ feedback method according to embodiments of the present disclosure;

FIG. 8 is a block diagram of an HARQ feedback apparatus according to embodiments of the present disclosure;

FIG. 9 is a block diagram of an HARQ feedback apparatus according to embodiments of the present disclosure;

FIG. 10 is a block diagram of an HARQ feedback apparatus according to embodiments of the present disclosure;

FIG. 11 is a block diagram of an HARQ feedback apparatus according to embodiments of the present disclosure; and

FIG. 12 is a schematic diagram of a structure of a communication device according to embodiments of the present disclosure.

### DETAILED DESCRIPTION

In order to make the purpose, technical solutions, and advantages of the present disclosure clearer, a further detailed description of embodiments of the present disclosure will be provided in the following in conjunction with the drawings.

A detailed explanation of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

The terms used in present disclosure are for the purpose of describing specific embodiments only and are not intended to limit the present disclosure. The singular form used in the present disclosure and the appended claims is also intended to include the multiple form, unless the context clearly indicates otherwise. It should also be understood that the term “and/or” used herein refers to and includes any or all possible combinations of one or more related items listed.

It should be understood that although various information may be described using terms such as first, second, and third in present disclosure, such information should not be limited to these terms. These terms are only used to distinguish information of the same type from each other. For example, without departing from the scope of the present disclosure, the first information can also be referred to as the second information, and similarly, the second information can also be referred to as the first information. For example, the word “if” used herein can be interpreted as “when”, or “while”, or “in response to determination”, depending on the context.

An explanation of an application scenario of the present disclosure will be provided in the following.

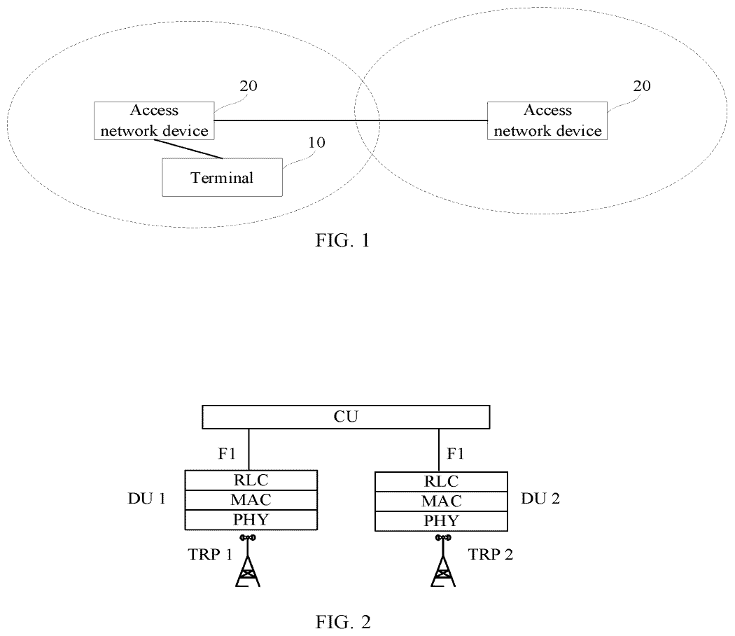

FIG. 1 illustrates a block diagram of a communication system according to embodiments of the present disclosure. The communication system can include a terminal 10 and an access network device 20.

The terminal 10 can be multiple terminals 10. Each cell managed by the access network device 20 can have one or more terminals 10 to be distributed therein. For the convenience of description, in embodiments of the present disclosure, the devices mentioned above are collectively referred to as terminals. The terminal 10 can include various devices with wireless communication capabilities, such as handheld devices, vehicle mounted devices, wearable devices, computing devices or other processing devices connected to the wireless modem, as well as various forms of user equipment (UE), mobile stations (MS), and so on.

The access network device 20 is a device deployed in the access network to provide wireless communication functionality for the terminal 10. For the convenience of description, in embodiments of the present disclosure, the devices mentioned above that provides wireless communication functionality for the terminal 10 are collectively referred to as access network devices. The connection between the access network device 20 and the terminal 10 can be established through a radio interface, and the access network device 20 and the terminal 10 can communicate through the connection, including signaling and data exchange. The access network device 20 can be multiple access network devices 20, and adjacent access network devices 20 can also communicate with each other through wired or wireless means. The terminal 10 can switch between different access network devices 20, that is, the terminal 10 can establish the connection with different access network devices 20.

In some embodiments, the access network device is a TRP (Transmit-Receive Point) device, or the access network device 20 can include various forms of macro base stations, micro base stations, relay stations, access points, and so on. In systems using different wireless access technologies, the names of the devices with access network device functionality may vary. For example, in the 5G NR system, the access network device is called gNodeB or gNB. With the evolution of the communication technology, the name “access network device” may change.

In some embodiments, the access network device 20 is a TRP device, and the access network device 20 can be controlled by a DU (Distributed Unit). One DU can control multiple access network devices 20 or one access network device 20, and different DUs can belong to the same CU (Centralized Unit) or different CUs. In some embodiments, one CU can control at least one DU.

That the access network device 20 is the TRP is taken as an example. The communication system of the present disclosure will be explained referring to FIG. 2. The communication system includes a CU, and the CU controls two DUs, namely DU1 and DU2. The DU1 and DU2 each includes an RLC (Radio Link Control) layer, an MAC (Medium Access Control) layer, and a PHY (Port Physical Layer) layer. DU1 controls TRP1 and DU2 controls TRP2.

The “5G NR system” in the present disclosure can also be referred to as the 5G system or the NR system, and those skilled in the art can understand the meaning thereof. The technical solution provided in embodiments of present disclosure can be applicable to the 5G NR system, as well as to subsequent evolutionary systems for 5G NR systems.

For the terminal that can communicate with the access network device through beams used for the neighboring cell, in the case where the terminal receives downlink data through beams used for the serving cell and the terminal needs to send HARQ information for the downlink data, the HARQ information would not be returned appropriately after the terminal has switched to communicate with the access network device through the beams used for the neighboring cell.

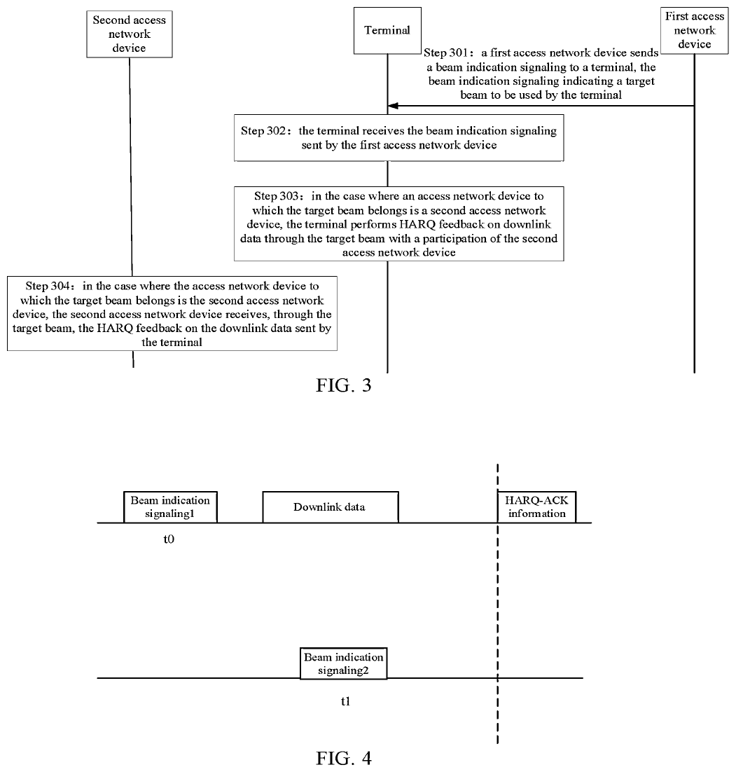

FIG. 3 illustrates a flowchart of an HARQ feedback method according to embodiments of the present disclosure, which can be applied to the terminal and the access network device as shown in FIG. 1. The method includes at least some of the following.

In step 301, a first access network device sends a beam indication signaling to a terminal, the beam indication signaling indicating a target beam to be used by the terminal.

In step 302, the terminal receives the beam indication signaling sent by the first access network device.

In some embodiments of the present disclosure, the first access network device sends the beam indication signaling to the terminal, and after receiving the beam indication signaling, the terminal determines based on the beam indication signaling which target beam(s) to use for data transmission follow-up.

In some embodiments, the beam indication signaling is either the DCI (Downlink Control Information) signaling, or the MAC CE (MAC Control Element) signaling.

In step 303, in the case where an access network device to which the target beam belongs is a second access network device, the terminal performs HARQ feedback on downlink data through the target beam with a participation of the second access network device.

In some embodiments of the present disclosure, the terminal receives the downlink data sent by the first access network device, and the terminal needs to perform HARQ feedback based on the downlink data. The target beam indicated by the first access network device may not belong to the first access network device, and thus the terminal determines how to perform the HARQ feedback by determining whether an access network device to which the target beam belongs is a second access network device. In the case where the access network device to which the target beam belongs is the second access network device, and if the HARQ feedback is required to be performed, the terminal needs to perform the HARQ feedback on the downlink data through the target beam with the participation of the second access network device. The second access network device and the first access network device are different access network devices.

It should be noted that the above embodiments are all based on a fact that the access network device to which the target beam belongs and the access network device to which the currently used beam belongs are different access network devices. In some embodiments, whether the HARQ feedback is to be performed or not will be determined based on the DU or CU corresponding to the access network device to which the target beam belongs.

In some embodiments, that the access network device to which the target beam belongs is the second access network device, can include any of the following situations.

(1) The DU corresponding to the second access network device is different from the DU corresponding to the first access network device, and the access network device to which the target beam belongs is the second access network device.

In some embodiments, the beam indication signaling includes a TCI (Transmission Configuration Indication) state, and the TCI state includes DU identification information indicating the DU to which the target beam belongs.

In some embodiments, the DU identification information is an ID (Identity Document) of the DU, or a name of the DU, or other information of the DU, which is not limited in embodiments of the present disclosure.

If the identification information of the DU corresponding to the access network device to which the target beam belongs is different from the identification information of the DU corresponding to the access network device to which the currently used beam belongs, it indicates that the DU corresponding to the access network device to which the target beam belongs is different from the DU corresponding to the access network device to which the currently used beam belongs.

In some embodiments, the DU identification information is a gNB-DU ID. When the first access network device indicates the target beam, the terminal determines based on the gNB-DU ID whether the access network device to which the target beam belongs is the second access network device or not. If the gNB-DU ID is different from a corresponding gNB-DU ID of the first access network device, it indicates that the access network device to which the target beam belongs is the second access network device.

In some embodiments, the access network devices with different gNB-DU IDs belong to the same gNB, and the gNB-DU ID is used to indicate different access network devices or the same access network device, which belong to the same gNB.

(2) The CU corresponding to the second access network device is different from the CU corresponding to the first access network device, and the access network device to which the target beam belongs is the second access network device.

In some embodiments, the beam indication signaling includes a TCI state, and the TCI state includes CU identification information indicating the CU to which the target beam belongs.

In some embodiments, the CU identification information is an ID of the CU, or a name of the CU, or other information of the CU, which is not limited in embodiments of the present disclosure.

If the identification information of the CU corresponding to the access network device to which the target beam belongs is different from the identification information of the CU corresponding to the access network device to which the currently used beam belongs, it indicates that the CU corresponding to the access network device to which the target beam belongs is different from the CU corresponding to the access network device to which the currently used beam belongs.

In step 304, in the case where the access network device to which the target beam belongs is the second access network device, the second access network device responds to, through the target beam, the HARQ feedback on the downlink data from the terminal.

In some embodiments of the present disclosure, if the access network device to which the target beam (indicated by the first access network device) belongs is different from the access network device to which the currently used beam belongs, the terminal needs to make the HARQ feedback on the downlink data be performed between the second access network device and the terminal, and the second access network device also needs to responds to, through the target beam, the HARQ feedback on the downlink data from the terminal.

In some embodiments, as shown in FIG. 4, at time to, the terminal receives the beam indication signaling 1 sent by the first access network device, which also sends the downlink data after time t0. At time t1, the terminal receives additionally the beam indication signaling 2 sent by the first access network device. When feeding back the HARQ feedback information for the downlink data, the beam indicated by the beam indication signaling 2 which is received at time t1 has been used. Therefore, it is necessary to determine based on the access network device to which the beam belongs how to perform the HARQ feedback.

It should be noted that in the above embodiments, in the case where the access network device to which the target beam belongs is the second access network device, the first access network device indicates to the second access network device that the HARQ feedback on the downlink data is performed between the second access network device and the terminal through the target beam.

It should be noted that steps performed by the terminal in some embodiments of the present disclosure can form separately new embodiments, steps performed by the first access network device in some embodiments of the present disclosure can also form separately new embodiments, and steps performed by the second access network device in some embodiments of the present disclosure can also form separately new embodiments.

According to the methods provided in embodiments of present disclosure, the terminal can determine based on the beam indication signaling sent by the access network device whether the access network device to which the target beam belongs is the second access network device. When the terminal determines that the access network device to which the target beam belongs is the second access network device, the HARQ feedback on the downlink data is performed. The present disclosure provides a new HARQ feedback method to ensure the reliability of the data transmission.

Based on the embodiments shown in FIG. 3, if the terminal does not send HRAQ feedback information for the downlink data, the first access network device may have two choices to cope with such case, which will be explained in the following.

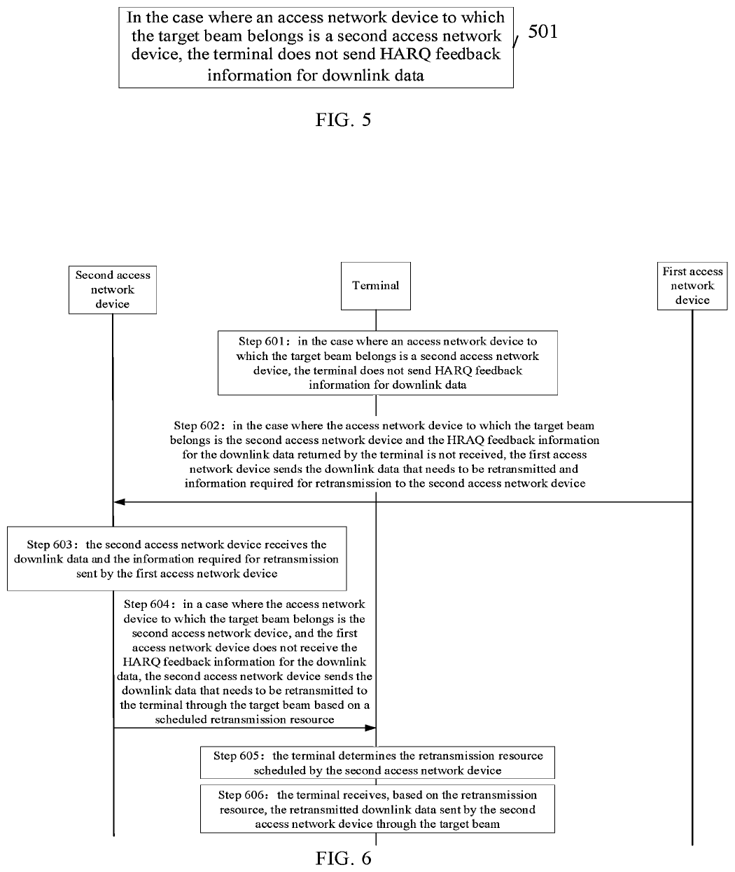

In the first choice, the communication protocol stipulates that the terminal is defaulted to have successfully received the downlink data, which will be explained in the following with reference to FIG. 5.

In step 501, in the case where an access network device to which the target beam belongs is a second access network device, the terminal does not send HARQ feedback information for downlink data.

In some embodiments of the present disclosure, if the terminal has determined that the access network device to which the target beam belongs is different from the access network device to which the currently used beam belongs, then the terminal does not need to return the HARQ feedback information for the downlink data after the downlink data is received.

In some embodiments, if the first access network device does not receive the HARQ feedback information for the downlink data returned by the terminal after it sends the downlink data to the terminal, it is determined that the terminal is indicated to have successfully received the downlink data by not sending the HARQ feedback information. After sending the downlink data to the terminal, the first access network device directly defaults that the downlink data sent to the terminal is received successfully, and also defaults that the terminal will not return the HARQ feedback information for the downlink data.

It should be noted that the terminal does not send the HARQ feedback information for the downlink data and the first access network device defaults that the downlink data has been successfully sent, which are both stipulated by the communication protocol.

According to the methods provided in embodiments of the present disclosure, in the case where the access network device to which the target beam belongs is the second access network device, the terminal can inform the first access network device by not sending the HARQ feedback information that the downlink data has been successfully received.

In the second choice, the communication protocol stipulates that the terminal has not received the downlink data correctly, which will be explained in the following with reference to FIG. 6.

In step 601, in the case where an access network device to which the target beam belongs is a second access network device, the terminal does not send HARQ feedback information for downlink data.

In some embodiments of the present disclosure, if the terminal has determined that the access network device to which the target beam belongs is the second access network device, then the terminal does not need to feed back the HARQ feedback information for the downlink data. The first access network device defaults that the terminal has not correctly received the downlink data, and the second access network device will perform the retransmission of the downlink data.

In step 602, in the case where the access network device to which the target beam belongs is the second access network device and the HRAQ feedback information for the downlink data returned by the terminal is not received, the first access network device sends the downlink data that needs to be retransmitted and information required for retransmission to the second access network device.

In step 603, the second access network device receives the downlink data and the information required for retransmission sent by the first access network device.

It should be noted that the terminal does not send the HARQ feedback information for the downlink data and the first access network device sends the downlink data that needs to be retransmitted, which are both stipulated by the communication protocol.

In some embodiments of the present disclosure, in the case where the access network device to which the target beam belongs is the second access network device, and after the first access network device sends the downlink data to the terminal, the first access network device determines that the downlink data, for which the HARQ feedback information cannot be returned normally. The terminal will not return the HARQ feedback information for these downlink data. The first access network device then defaults that the terminal has not received the downlink data sent to it. Since the terminal communicates through the target beam at this moment, and the target beam belongs to the second access network device, the first access network device sends the downlink data that needs to be retransmitted and the information required for retransmission to the second access network device. The second access network device receives the downlink data that needs to be retransmitted and the information required for retransmission sent by the first access network device.

In step 604, in a case where the access network device to which the target beam belongs is the second access network device, and the first access network device does not receive the HARQ feedback information for the downlink data, the second access network device sends the downlink data that needs to be retransmitted to the terminal through the target beam based on a scheduled retransmission resource.

In some embodiments of the present disclosure, if the access network device to which the target beam belongs is the second access network device, and if the first access network device does not receive the HARQ feedback information for the downlink data, it indicates that the terminal has not received the downlink data sent by the first access network device, and the downlink data retransmission needs to be performed. Since the data transmission by the terminal is performed through the target beam at this moment, the second access network device sends the downlink data that needs to be retransmitted to the terminal through the target beam based on the scheduled retransmission resource.

In some embodiments, the retransmission resource is scheduled by the second access network device, and is used for the second access network device to send the downlink data that needs to be retransmitted.

In some embodiments, the second access network device sends the DCI to the terminal to call the PDSCH (Physical Downlink Shared Channel) configured for the downlink data retransmission, and the HARQ process identifier corresponding to the downlink data to be retransmitted and the target data are both included in the DCI.

In some embodiments, the HARQ process identifier corresponding to the retransmitted downlink data is the same as the HARQ process identifier corresponding to the downlink data sent by the first access network device, and the retransmitted downlink data corresponds to a target value. The target value indicates that the retransmitted downlink data is the downlink data that needs to be retransmitted.

In some embodiments, the target value is 1, or the target value is 0.

In some embodiments of the present disclosure, since the second access network device sends the retransmitted downlink data in the case where the terminal does not receive the downlink data sent by the first access network device, the HARQ process identifier corresponding to the downlink data sent by the second access network device is the same as the HARQ process identifier corresponding to the downlink data sent by the first access network device, and the target value is used to indicate that the downlink data is retransmitted downlink data rather than newly transmitted data.

In step 605, the terminal determines the retransmission resource scheduled by the second access network device.

In step 606, the terminal receives, based on the retransmission resource, the retransmitted downlink data sent by the second access network device through the target beam.

In some embodiments of the present disclosure, if the second access network device schedules the retransmission resource for the terminal through DCI, the terminal can determine the retransmission resource scheduled by the second access network device, and can receive based on the retransmission resource the retransmitted downlink data sent by the second access network device through the target beam.

In some embodiments, the second access network device schedules PDSCH resource and performs the downlink data retransmission through the PDSCH resource.

In some embodiments, the second access network device sends scheduled information to the terminal, and after receiving the scheduled information sent by the second access network device, the terminal can determine the retransmission resource scheduled by the second access network device, and thus receive the retransmitted downlink data based on the retransmission resource.

According to the methods provided in embodiments of the present disclosure, in the case where the access network device to which the target beam belongs is the second access network device, the terminal does not send the HARQ feedback information, and the second access network device sends the retransmitted downlink data, so as to ensure the reliability of data transmission.

Based on the embodiments shown in FIG. 3, the terminal can also feedback the HARQ feedback information for the downlink data through a configured resource. How to provide the HARQ feedback information will be explained in the following.

In the case where the access network device to which the target beam belongs is the second access network device, the terminal sends, based on a first resource scheduled by the first access network device, the HARQ feedback information for the downlink data to the second access network device through the target beam. The first access network device sends the scheduled first resource to the second access network device.

In some embodiments of the present disclosure, in the case where the access network device to which the target beam belongs is the second access network device, and if the first access network device has already configured the first resource, the terminal can send, directly based on the first resource scheduled by the first access network device, the HARQ feedback information for the downlink data to the second access network device through the target beam.

In some embodiments, the first access network device will send the first resource scheduled by itself to the second access network device. Therefore, when the terminal sends the HARQ feedback information based on the first resource scheduled by the first access network device, the second access network device can receive the HARQ feedback information.

In some embodiments, the HARQ feedback information includes ACK (Acknowledgment information) and NACK (Negative-Acknowledgment information). The ACK indicates that the terminal has successfully received the downlink data, and the NACK indicates that the terminal has not received the downlink data.

It should be noted that in the case where the access network device to which the target beam belongs is the second access network device, the terminal will send the HARQ feedback information to the second access network device based on the first resource scheduled by the first access network device. In the case where the access network device to which the target beam belongs is the second access network device, based on the first resource scheduled by the first access network device, the second access network device will receive through the target beam the HARQ feedback information for the downlink data sent by the terminal.

It should be noted that the above embodiments explain how the terminal feeds back the HARQ feedback information. In some embodiments, in the case where the HRAQ feedback information provided by the terminal is NACK, the terminal needs to determine the retransmission resource scheduled by the second access network device and receive, based on the retransmission resource, the retransmitted downlink data sent by the second access network device.

In some embodiments of the present disclosure, the second access network device schedules a retransmission resource, and sends the retransmitted downlink data to the terminal based on the scheduled retransmission resource. The terminal then receives, based on the determined retransmission resource, the retransmitted downlink data sent by the second access network device.

In some embodiments, the HARQ process identifier corresponding to the retransmitted downlink data is the same as the HARQ process identifier corresponding to the downlink data sent by the first access network device, and the retransmitted downlink data corresponds to a target value. The target value indicates that the retransmitted downlink data is the downlink data that needs to be retransmitted.

In some embodiments, the target value is 1, or the target value is 0.

In some embodiments, the second access network device sends the DCI to the terminal to call the PDSCH configured for the downlink data retransmission, and the HARQ process identifier corresponding to the downlink data to be retransmitted and the target data are both included in the DCI.

In some embodiments of the present disclosure, since the second access network device sends the retransmitted downlink data in the case where the terminal does not receive the downlink data sent by the first access network device, the HARQ process identifier corresponding to the downlink data sent by the second access network device is the same as the HARQ process identifier corresponding to the downlink data sent by the first access network device, and the target value is used to indicate that the downlink data is retransmitted downlink data rather than newly transmitted data.

According to the methods provided in embodiments of the present disclosure, the first access network device sends the scheduled first resource to the second access network device, and the second access network device can then, based on the first resource scheduled by the first access network device, receive through the target beam the HARQ feedback information sent by the terminal, so as to ensure the reliability of data transmission.

It should be noted that the first resource configured by the first access network device can be the same or different from the second resource configured by the second access network device. However, regardless of whether the first resource configured by the first access network device is the same as the second resource configured by the second access network device, the first access network device sends the configured first resource to the second access network device, and the second access network device then receives the HARQ feedback information based on the first resource sent by the first access network device.

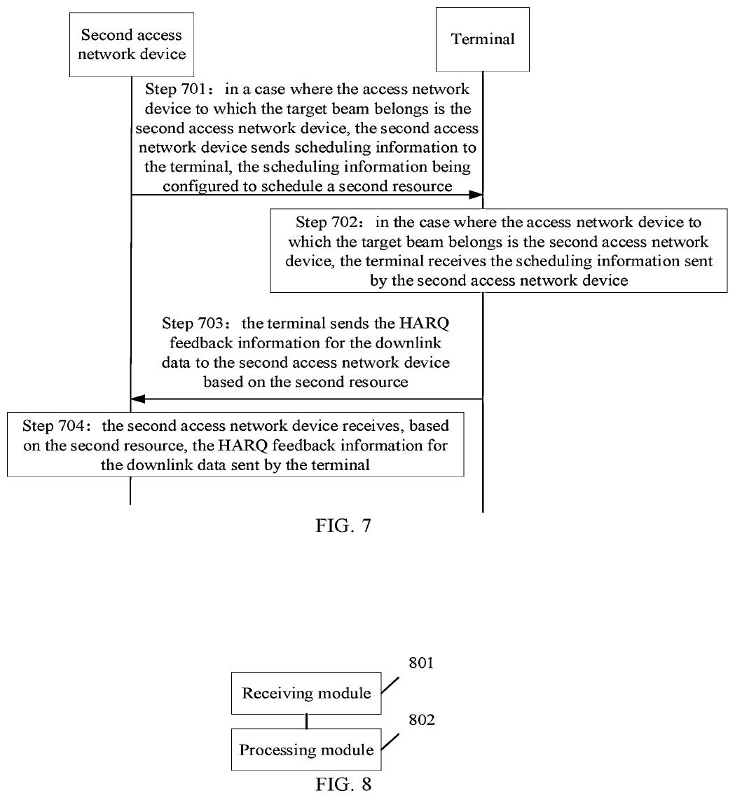

Based on the embodiments shown in FIG. 3, the terminal returns the HARQ feedback information based on the second resource scheduled by the second access network device, which will be explained in the following with reference to FIG. 7.

In step 701, in a case where the access network device to which the target beam belongs is the second access network device, the second access network device sends scheduling information to the terminal, the scheduling information being configured to schedule a second resource.

In step 702, in the case where the access network device to which the target beam belongs is the second access network device, the terminal receives the scheduling information sent by the second access network device.

In some embodiments of the present disclosure, in the case where the access network device to which the target beam belongs is the second access network device, and the HARQ feedback information for the downlink data sent by the first access network device needs to be fed back through the target beam, for those downlink data for which the HARQ feedback information needs to be fed back, the second access network device will schedule the second resource for the terminal by using the scheduling information, and the terminal will receive the scheduling information sent by the second access network device. The terminal can determine the second resource scheduled by the second access network device based on the scheduling information, and send the HARQ feedback information for the downlink data based on the scheduled second resource.

In some embodiments, if the scheduling information is carried in the DCI signaling, then the DCI signaling can be DCI format 0_1, DCI format 1_1, or other values.

In some embodiments, the scheduling information further includes information indicating the second resource configured for sending the HARQ feedback information for the downlink data to be fed back. In some embodiments, the scheduling information includes 1 bit, and the bit can be 0 or 1, which is not limited in embodiments of the present disclosure.

In step 703, the terminal sends the HARQ feedback information for the downlink data to the second access network device based on the second resource.

In step 704, the second access network device receives, based on the second resource, the HARQ feedback information for the downlink data sent by the terminal.

In some embodiments of the present disclosure, if the second access network device has scheduled the second resource for the terminal, then the terminal, when the HARQ feedback information for the downlink data needs to be fed back, will send the HARQ feedback information for the downlink data to the second access network device based on the second resource scheduled by the second access network device for the terminal. The second access network device will also receive based on the second resource the HARQ feedback information sent by the terminal.

In some embodiments, in the case where the access network device to which the target beam belongs is the second access network device, the terminal saves the HARQ feedback information for the downlink data and sends the HARQ feedback information to the second access network device based on the second resource.

In some embodiments, if the terminal determines that the access network device to which the target beam belongs is the second access network device, then the terminal will save at this moment the HARQ feedback information corresponding to the downlink data. These HARQ feedback information needs to be fed back through the target beam. When the HARQ feedback information for the downlink data needs to be fed back, the terminal sends the HARQ feedback information to the second access network device based on the second resource scheduled by the second access network device.

According to the methods provided in embodiments of the present disclosure, the terminal returns the HARQ feedback information based on the second resource scheduled by the second access network device, which can ensure the reliability of data transmission by the terminal.

It should be noted that the above embodiments of the present disclosure explain how the terminal returns the HARQ feedback information. In the case where the HARQ feedback information returned by the terminal is NACK, the terminal needs to determine the retransmission resource scheduled by the second access network device, and receive, based on the scheduled retransmission resource, the retransmitted downlink data sent by the second access network device.

In some embodiments of the present disclosure, the second access network device schedules the retransmission resource and sends the retransmitted downlink data to the terminal based on the scheduled retransmission resource. The terminal receives the retransmitted downlink data from the second access network device based on the determined retransmission resource.

In some embodiments, the HARQ process identifier corresponding to the retransmitted downlink data is the same as the HARQ process identifier corresponding to the downlink data sent by the first access network device, and the retransmitted downlink data corresponds to a target value. The target value indicates that the retransmitted downlink data is the downlink data that needs to be retransmitted.

In some embodiments, the target value is 1, or the target value is 0.

In some embodiments of the present disclosure, since the second access network device sends the retransmitted downlink data in the case where the terminal does not receive the downlink data sent by the first access network device, the HARQ process identifier corresponding to the downlink data sent by the second access network device is the same as the HARQ process identifier corresponding to the downlink data sent by the first access network device, so as to indicate the downlink data retransmission process executed by the second access network device. The target value is used to indicate that the downlink data is retransmitted downlink data rather than newly transmitted data.

It should be noted that the above embodiments can be divided into new embodiments or combined with other embodiments to form new embodiments. The present disclosure does not limit the combination between embodiments.

FIG. 8 illustrates a block diagram of an HARQ feedback apparatus according to embodiment of the present disclosure. As shown in FIG. 8, the HARQ feedback apparatus includes a receiving module 801 and a processing module 802.

The receiving module 801 is configured to receive a beam indication signaling sent by a first access network device, the beam indication signaling being configured to indicate a target beam to be used by the terminal.

The processing module 802 is configured to in the case where an access network device to which the target beam belongs is a second access network device, perform HARQ (Hybrid Automatic Repeat Request) feedback for downlink data through the target beam together with the second access network device.

In some embodiments, the beam indication signaling includes a TCI state, and the TCI state includes at least one of: DU identification information configured to indicate a DU to which the target beam belongs; or CU identification information configured to indicate a CU to which the target beam belongs.

In some embodiments, the processing module 802 is further configured to: in the case where the access network device to which the target beam belongs is the second access network device, prevent sending of HARQ feedback information for the downlink data.

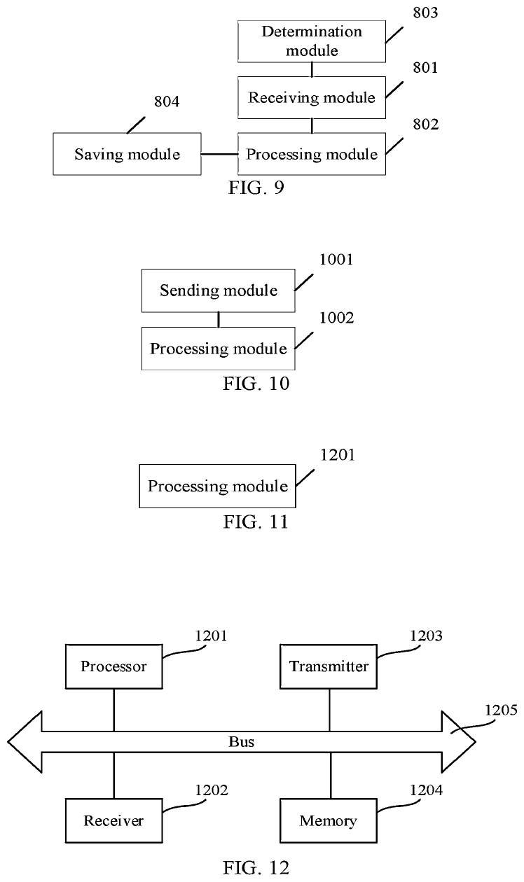

In some embodiments, as shown in FIG. 9, the apparatus further includes a determination module 803.

The determination module 803 is configured to determine a retransmission resource scheduled by the second access network device.

The receiving module 801 is configured to receive, based on the retransmission resource, retransmitted downlink data sent by the second access network device through the target beam.

In some embodiments, the second access network device sends the retransmitted downlink data in the case where the first access network device does not receive the HARQ feedback information for the downlink data, and the downlink data and information required for retransmission are sent to the second access network device by the first access network device.

In some embodiments, the processing module 802 is further configured to: in the case where the access network device to which the target beam belongs is the second access network device, send, based on a first resource scheduled by the first access network device, HARQ feedback information for the downlink data to the second access network device through the target beam, the first resource scheduled being sent to the second access network device by the first access network device.

In some embodiments, the processing module 802 is further configured to: in the case where the access network device to which the target beam belongs is the second access network device, receive scheduling information sent by the second access network device, the scheduling information being configured to schedule a second resource; and send, based on the second resource, HARQ feedback information for the downlink data to the second access network device.

In some embodiments, as shown in FIG. 9, the apparatus further includes a saving module 804.

The saving module 804 is configured to: in the case where the access network device to which the target beam belongs is different from the access network device to which a currently used beam belongs, save the HARQ feedback information for the downlink data.

In some embodiments, the HARQ feedback information is NACK, and the determination module 803 is further configured to a retransmission resource scheduled by the second access network device.

The processing module 802 is further configured to receive, based on the retransmission resource, retransmitted downlink data sent by the second access network device.

In some embodiments, the HARQ process identifier corresponding to the retransmitted downlink data is the same as the HARQ process identifier corresponding to the downlink data sent by the first access network device, and the retransmitted downlink data corresponds to the target value configured to indicate that the retransmitted downlink data is retransmitted data.

In some embodiments, the beam indication signaling is a DCI (Downlink Control Information) signaling, or the beam indication signaling is an MAC CE (Medium Access Control Control Element) signaling.

In some embodiments, the access network device to which the target beam belongs being the second access network device, includes any of following cases: a DU corresponding to the second access network device is different from a DU corresponding to the first access network device, and the access network device to which the target beam belongs is the second access network device; or a CU corresponding to the second access network device is different from a CU corresponding to the first access network device, and the access network device to which the target beam belongs is the second access network device.

It should be noted that the apparatus provided in the above embodiments only provides examples of the division of each functional module when realizing functions of the apparatus. In practical applications, the above functions can be assigned to different functional modules according to needs. That is, the internal structure of the apparatus can be divided into different functional modules to complete all or part of the functions described above. In addition, the apparatus and method embodiments provided in the above are based on the same concept, and the specific implementation process is detailed in the method embodiments, which will not be repeated here.

FIG. 10 illustrates a block diagram of an HARQ feedback apparatus according to embodiment of the present disclosure. As shown in FIG. 10, the HARQ feedback apparatus includes a sending module 1001 and a processing module 1002.

The sending module 1001 is configured to a beam indication signaling to a terminal, the beam indication signaling being configured to indicate a target beam to be used by the terminal.

The processing module 1002 is configured to: in the case where an access network device to which the target beam belongs is a second access network device, indicate to the second access network device to enable the second access network device to perform HARQ (Hybrid Automatic Repeat Request) feedback for downlink data through the target beam together with the terminal.

In some embodiments, the beam indication signaling includes a TCI state, and the TCI state includes at least one of: DU identification information, configured to indicate a DU to which the target beam belongs; or CU identification information, configured to indicate a CU to which the target beam belongs.

In some embodiments, the processing module 1002 is further configured to: in the case where the access network device to which the target beam belongs is the second access network device and HRAQ feedback information for the downlink data returned by the terminal is not received, send the downlink data and information required for retransmission to the second access network device

In some embodiments, the processing module 1002 is further configured to: in the case where the access network device to which the target beam belongs is the second access network device, send a scheduled second resource to the second access network device to enable the second access network device to receive, based on the scheduled second resource, HARQ feedback information sent by the terminal.

In some embodiments, the access network device to which the target beam belongs being the second access network device, includes any of following cases: a DU corresponding to the second access network device is different from a DU corresponding to the first access network device, and the access network device to which the target beam belongs is the second access network device; or a CU corresponding to the second access network device is different from a CU corresponding to the first access network device, and the access network device to which the target beam belongs is the second access network device.

It should be noted that the apparatus provided in the above embodiments only provides examples of the division of each functional module when realizing functions of the apparatus. In practical applications, the above functions can be assigned to different functional modules according to needs. That is, the internal structure of the apparatus can be divided into different functional modules to complete all or part of the functions described above. In addition, the apparatus and method embodiments provided in the above are based on the same concept, and the specific implementation process is detailed in the method embodiments, which will not be repeated here.

FIG. 11 illustrates a block diagram of an HARQ feedback apparatus according to embodiment of the present disclosure. As shown in FIG. 11, the HARQ feedback apparatus includes a processing module 1101.

The processing module 1101 is configured to: in the case where an access network device to which a target beam belongs is the second access network device, receiving, through the target beam, HARQ feedback for downlink data sent by a terminal; the target beam being indicated to the terminal by a first access network device through a beam indication signaling.

In some embodiments, the beam indication signaling includes a TCI state, and the TCI state includes at least one of: DU identification information, configured to indicate a DU to which the target beam belongs; or CU identification information, configured to indicate a CU to which the target beam belongs.

In some embodiments, the processing module 1101 is further configured to: in the case where the access network device to which the target beam belongs is the second access network device and the first access network device does not receive HARQ feedback information for the downlink data, send, based on a scheduled retransmission resource, retransmitted downlink data to the terminal through the target beam; the downlink data and information required for retransmission being sent to the second access network device by the first access network device.

In some embodiments, in processing module 1101 is further configured to: in the case where the access network device to which the target beam belongs is the second access network device, based on a first resource scheduled by the first access network device, receive, through the target beam, HARQ feedback information for the downlink data sent by the terminal, the first resource scheduled is sent to the second access network device by the first access network device.

In some embodiments, the processing module 1101 is further configured to: in the case where the access network device to which the target beam belongs is the second access network device, send scheduling information to the terminal, the scheduling information being configured to schedule a second resource; and receive, based on the second resource, HARQ feedback information for the downlink data sent by the terminal.

In some embodiments, the HARQ feedback information is NACK, and the processing module 1101 is further configured to: send, based on a scheduled retransmission resource, retransmitted downlink data to the terminal.

In some embodiments, the HARQ process identifier corresponding to the retransmitted downlink data is the same as the HARQ process identifier corresponding to the downlink data sent by the first access network device, and the retransmitted downlink data corresponds to a target value configured to indicate that the retransmitted downlink data is retransmitted data.

In some embodiments, the beam indication signaling is a DCI signaling, or the beam indication signaling is an MAC CE signaling.

In some embodiments, the access network device to which the target beam belongs being the second access network device, includes any of following cases: a DU corresponding to the second access network device is different from a DU corresponding to the first access network device, and the access network device to which the target beam belongs is the second access network device; or a CU corresponding to the second access network device is different from a CU corresponding to the first access network device, and the access network device to which the target beam belongs is the second access network device.

It should be noted that the apparatus provided in the above embodiments only provides examples of the division of each functional module when realizing functions of the apparatus. In practical applications, the above functions can be assigned to different functional modules according to needs. That is, the internal structure of the apparatus can be divided into different functional modules to complete all or part of the functions described above. In addition, the apparatus and method embodiments provided in the above are based on the same concept, and the specific implementation process is detailed in the method embodiments, which will not be repeated here.

FIG. 12 illustrates a schematic diagram of a structure of a communication device according to embodiments of the present disclosure. The communication device includes a processor 1201, a receiver 1202, a transmitter 1203, a memory 1204, and a bus 1205.

The processor 1201 includes one or more processing cores, which execute various functional applications and information processing by running software programs and modules.

The receiver 1202 and the transmitter 1203 can be embodied as a communication component, which can be a communication chip.

The memory 1204 is connected to the processor 1201 via the bus 1205.

The memory 1204 can be configured to store at least one program code, and the processor 1201 is configured to execute the at least one program code to implement the various steps in the above method embodiments.

In addition, the communication device can be a terminal or an access network device. The memory 1204 can be embodied by any type of volatile or non-volatile storage device, or a combination thereof. Volatile or non-volatile storage devices include but are not limited to: magnetic disks or optical discs, electrically erasable programmable read-only memory (EEPROM), erasable programmable read-only memory (EPROM), static random-access memory (SRAM), read-only memory (ROM), magnetic memory, flash memory, and programmable read-only memory (PROM).

In some embodiments, a computer-readable storage medium is also provided, which stores executable program codes, and the executable program codes can be loaded and executed by a processor to implement the HARQ feedback methods executed by a communication device provided in the above method embodiments.

In some embodiments, a chip is provided, which includes programmable logic circuits and/or program instructions, for implementing the HARQ feedback methods provided in the above method embodiments when the chip runs on a terminal or an access network device.

In some embodiments, a computer program product is provided for implementing the HARQ feedback methods provided in the above method embodiments when the computer program product is executed by a processor of a terminal or an access network device.

Those of ordinary skill in the art can understand that all or part of the steps to implement the above embodiments can be completed through hardware, or by instructing relevant hardware through programs. The programs can be stored in a computer-readable storage medium, which can be read-only memory, disk, or optical disc, etc.

The above description is only embodiments of present disclosure and is not intended to limit the present disclosure. Any modifications, equivalent substitutions, improvements, etc. made within the spirit and principle of the present disclosure shall be included within the protection scope of the present disclosure.

1. A Hybrid Automatic Repeat Request (HARQ) feedback method, performed by a terminal, the method comprising:
receiving a beam indication signaling sent by a first access network device, wherein the beam indication signaling is configured to indicate a target beam to be used by the terminal; and
in response to an access network device to which the target beam belongs being a second access network device, performing HARQ feedback for downlink data through the target beam together with the second access network device.

2. The method according to claim 1, wherein the beam indication signaling comprises a Transmission Configuration Indication (TCI) state, and the TCI state comprises at least one of:
Distributed Unit (DU) identification information, configured to indicate a DU to which the target beam belongs; or
Centralized Unit (CU) identification information, configured to indicate a CU to which the target beam belongs.

3. The method according to claim 1, wherein in response to the access network device to which the target beam belongs being the second access network device, performing the HARQ feedback for the downlink data through the target beam together with the second access network device, comprises:
in response to the access network device to which the target beam belongs being the second access network device, preventing sending of HARQ feedback information for the downlink data.

4. The method according to claim 3, further comprising:
determining a retransmission resource scheduled by the second access network device; and
receiving, based on the retransmission resource, retransmitted downlink data sent by the second access network device through the target beam,
wherein the second access network device sends the retransmitted downlink data in response to that the first access network device does not receive the HARQ feedback information for the downlink data, and the retransmitted downlink data and information required for retransmission are sent to the second access network device by the first access network device.

5. The method according to claim 1, wherein in response to the access network device to which the target beam belongs being the second access network device, performing the HARQ feedback for the downlink data through the target beam together with the second access network device, comprises:
in response to the access network device to which the target beam belongs being the second access network device, sending, based on a first resource scheduled by the first access network device, HARQ feedback information for the downlink data to the second access network device through the target beam, wherein the first resource scheduled by the first access network device is sent to the second access network device by the first access network device.

6. The method according to claim 1, wherein in response to the access network device to which the target beam belongs being the second access network device, performing the HARQ feedback for the downlink data through the target beam together with the second access network device, comprises:
in response to the access network device to which the target beam belongs being the second access network device, receiving scheduling information sent by the second access network device, wherein the scheduling information is configured to schedule a second resource; and
sending, based on the second resource, HARQ feedback information for the downlink data to the second access network device.

7. The method according to claim 1, further comprising:
in response to the access network device to which the target beam belongs being different from the access network device to which a currently used beam belongs, saving HARQ feedback information for the downlink data.

8. The method according to claim 5, further comprising:
in response to the HARQ feedback information being a Negative-Acknowledgment (NACK), determining a retransmission resource scheduled by the second access network device; and
receiving, based on the retransmission resource, retransmitted downlink data sent by the second access network device,
wherein the retransmitted downlink data and information required for retransmission are sent to the second access network device by the first access network device.

9. The method according to claim 4, wherein an HARQ process identifier corresponding to the retransmitted downlink data is the same as an HARQ process identifier corresponding to the downlink data sent by the first access network device, and the retransmitted downlink data corresponds to a target value configured to indicate that the retransmitted downlink data is downlink data that needs to be retransmitted.

10. The method according to claim 1, wherein the beam indication signaling is a Downlink Control Information (DCI) signaling, or the beam indication signaling is a Medium Access Control Control Element (MAC CE) signaling.

11. The method according to claim 1, wherein the access network device to which the target beam belongs being the second access network device, comprises any of following cases where:
a DU corresponding to the second access network device is different from a DU corresponding to the first access network device, and the access network device to which the target beam belongs is the second access network device; or
a CU corresponding to the second access network device is different from a CU corresponding to the first access network device, and the access network device to which the target beam belongs is the second access network device.

12. A Hybrid Automatic Repeat Request (HARQ) feedback method, performed by a first access network device, the method comprising:
sending a beam indication signaling to a terminal, wherein the beam indication signaling is configured to indicate a target beam to be used by the terminal; and
in response to an access network device to which the target beam belongs being a second access network device, indicating to the second access network device to enable the second access network device to perform HARQ feedback for downlink data through the target beam together with the terminal.

13. (canceled)

14. The method according to claim 12, wherein in response to the access network device to which the target beam belongs being the second access network device, indicating to the second access network device to enable the second access network device to perform the HARQ feedback for the downlink data through the target beam together with the terminal, comprises:
in response to that the access network device to which the target beam belongs is the second access network device and HRAQ feedback information for the downlink data returned by the terminal is not received, sending retransmitted downlink data and information required for retransmission to the second access network device.

15. The method according to claim 12, wherein in response to the access network device to which the target beam belongs being the second access network device, indicating to the second access network device to enable the second access network device to perform the HARQ feedback for the downlink data through the target beam together with the terminal, comprises:
in response to the access network device to which the target beam belongs being the second access network device, sending a scheduled first resource to the second access network device to enable the second access network device to receive, based on the scheduled first resource, HARQ feedback information sent by the terminal.

16. (canceled)

17. A Hybrid Automatic Repeat Request (HARQ) feedback method, performed by a second access network device, the method comprising:
in response to an access network device to which a target beam belongs being the second access network device, responding to, through the target beam, HARQ feedback for downlink data from a terminal,
wherein the target beam is indicated to the terminal by a first access network device through a beam indication signaling.

18-41. (canceled)

42. A terminal, comprising:
a processor; and
a transceiver connected to the processor,
wherein the processor is configured to load and execute executable instructions to implement the HARQ feedback method according to claim 1.

43. An access network device, comprising:
a processor; and
a transceiver connected to the processor,
wherein the processor is configured to load and execute executable instructions to implement the HARQ feedback method according to claim 12.

44-45. (canceled)

46. The method according to claim 6, further comprising:
in response to the HARQ feedback information being Negative-Acknowledgment (NACK), determining a retransmission resource scheduled by the second access network device; and
receiving, based on the retransmission resource, retransmitted downlink data sent by the second access network device,
wherein the retransmitted downlink data and information required for retransmission are sent to the second access network device by the first access network device.

47. The method according to claim 8, wherein an HARQ process identifier corresponding to the retransmitted downlink data is the same as an HARQ process identifier corresponding to the downlink data sent by the first access network device, and the retransmitted downlink data corresponds to a target value configured to indicate that the retransmitted downlink data is downlink data that needs to be retransmitted.

48. The method according to claim 46, wherein an HARQ process identifier corresponding to the retransmitted downlink data is the same as an HARQ process identifier corresponding to the downlink data sent by the first access network device, and the retransmitted downlink data corresponds to a target value configured to indicate that the retransmitted downlink data is downlink data that needs to be retransmitted.
